(19) United States
(12) Patent Application Publication
(10) Pub. No.: US 2009/0317028 A1
(43) Pub. Date: Dec. 24, 2009

(54) SEAL ASSEMBLY IN SITU LIFETIME MEASUREMENT

(76) Inventor: Larry Castleman, Monroeville, IN (US)

Correspondence Address: TAYLOR & AUST, P.C., P.O. Box 560, 142. S Main Street, Avilla, IN, 46710, US

(21) Appl. No.: 12/145,203

(22) Filed: Jun. 24, 2008

(51) Int. Cl. F16C 32/00; G08B 21/00

(52) U.S. Cl. 384/448; 340/682

(57) ABSTRACT

A bearing system for bearing between two members including a polymer bearing disposed between the two members, a measurement device disposed within the bearing for measuring an aspect of at least one of the bearing and the environment between the two members, the device creating a signal related to the measured aspect and a communication device for communicating the signal away from the polymer bearing.

### BACKGROUND OF THE INVENTION

1. Field of the Invention

The present invention relates to seal assemblies.

2. Description of the Related Art

It is known that at some times during use, seals and seal systems suffer a loss of sealing effectiveness. At times, in different applications, the loss of sealing performance leads only to a requirement for replacement of the seal. In other applications, loss of sealing performance can have effects ranging from a simple maintenance nuisance to an expensive resealing and cleaning operation, to even a potentially hazardous situation.

It would be beneficial, if a seal or seal system could indicate prior to total failure, that the seal or seal system has lost some, but not all, performance, and that a replacement seal or seal system is to be required in the near future. Current technology does not provide for an in situ measurement that continuously or semi-continuously measures some element of seal or seal performance during use.

Various seal and seal system combinations and applications could benefit from a function or feature of the seal that would indicate imminent loss of change of sealing performance, including o-ring type seals, face seals, labyrinth, rotary, dynamic and static type seals and others including elastomeric and polymeric composites, rubber, metal, fluroropolymers, or flurorocarbons, resins, and seals constructed from other constituents.

What is needed in the art is a seal or seal assembly having an embedded component or continuous material composition that permits measurement of the decay or change of sealing performance as the seal is being utilized in an application.

### SUMMARY OF THE INVENTION

The present invention provides a seal or seal assembly having an embedded component or continuous material composition that permits measurement of the decay or change of sealing performance as the seal is being utilized in an application. Various ways are envisioned for such a function to be implemented.

In one form of the invention, an individual sensor is inserted into the seal material with a sensing capability that allows continuous or semi-continuous measuring in an application the loss or change of sealing performance during the lifetime of the seal.

In another form of the invention, a continuous material is embedded in a seal member, the continuously embedded material composition having either an intrinsic or extrinsic sensing capability that allows for continuous or semi-continuous monitoring of sealing performance or loss of sealing ability, or some form of degradation or change of the seal and/or seal system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a partial cross sectional view of a generalized seal assembly in accordance with one embodiment of the present invention; and

FIG. 2 is a partial cross sectional view of another alternative embodiment of the invention, in which the seal element includes an embedded material composition that allows measurement of the decay in sealing performance.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

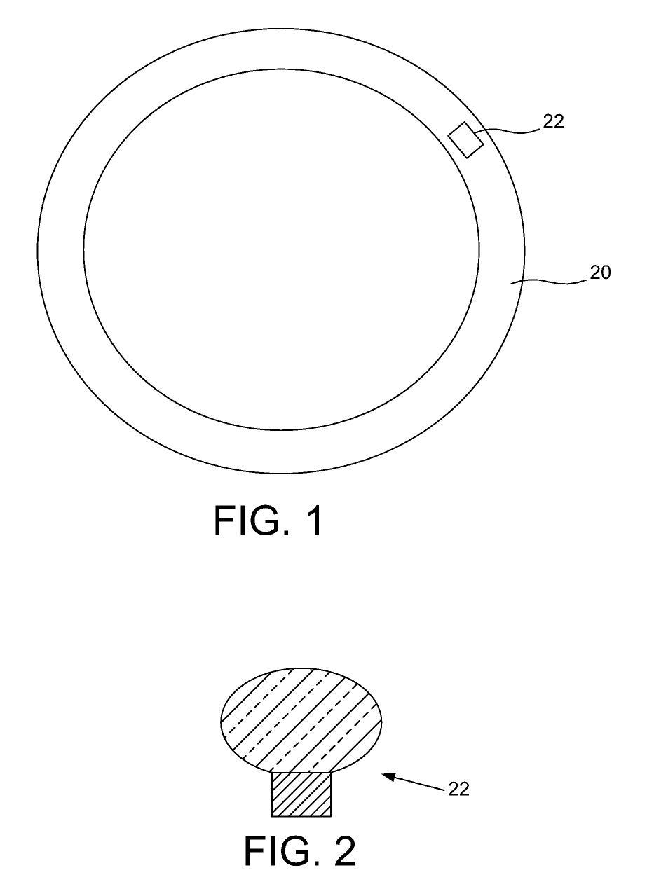

The present invention relates to seal assemblies and, more particularly, to a seal assembly that, while in an installed condition, can be measured or sensed to determine the potential decay or change of sealing performance. A seal assembly 20 in accordance with the present invention is shown in FIGS. 1-2. In the first embodiment of FIG. 1, there is shown generally an embedded sensor 22, that is to be used when the seal is disposed within an application.

The sensor 22 to be utilized could be one that measures a particular aspect of the seal or seal system in the pressurized or un-pressurized state, as long as the seal or seal system is disposed within the environment in which it seals. Sensor 22 could be one selected from a group of known sensors for measuring temperature, pressure, fluid, acceleration, resistance, vibration, stress, strain, electrical current, radiation (including x-ray, microwave, electromagnetic spectrum), ultrasonic sensors, or other physical phenomena. These sensor devices as just described and identified, would permit a signal in some form to be communicated outside the sealing environment, such that an indication of a change or loss of sealing performance which has occurred can be determined.

The sensor signals derived from this invention would have previously been cross compared with historical lifetime and historical time to failure data for the associated seal member or seal system, to create lookup tables showing change of seal performance. Therefore, once a signal was received from a corresponding sensor, a lookup table operation, such as one that could be operated by a microprocessor or operator, would be utilized to determine the likelihood of seal decay or change in seal or seal system performance. A memory, of a bearing signal processor assembly, including performance data and/or thresholds regarding a plurality of polymer bearing systems can be thus used. The historical performance data, as well as the thresholds, can be disposed in an Extensible Markup Language (XML) file.

Various ways of signaling sensor output or creating a sensor output device would include an electrical, optical, or other signal, either wired, piped, or wirelessly communicated out of the sealing environment to a display or other control unit for communication to alert an operator to replace the seal or seal system. A communication device for communicating the signal away from the polymer bearing is used. The communication device can be a radio-frequency identification (RFID) device.

Another form of the invention is shown in FIG. 2, which depicts a cross section of a seal member, with an embedded continuous material composition, that would give an indication of a change or loss of sealing ability of the seal member. The seal member could be disposed within a seal system.

For use in the present application, continuous material composition means that the embedded material is embedded at least one of axially, radially, longitudinally, or latitudinally across, over, or through the seal member. In portions of the application for readability, the word material is utilized and is therefore limited to the immediate above definition, and not to be confused with a base constituent or component of the seal or seal system.

In terms of construction methods, the material may be embedded into the seal member at the time of forming or molding, or associated with or on the seal member after forming or molding. Such continuous material composition may be utilized in addition to the embodiment of an embedded sensor, but in this case, the sensor would measure a particular feature of the embedded continuous material composition.

Various types of measurement could be accomplished on the embedded continuous material, that cross compares to changes in the seal or seal system performance. For example, the use and changes of carbon fibers as an embedded material shows promise in predicting and measuring seal performance. In this example, the changes of carbon fiber electrical resistance over time for test seals or seal systems are measured, and loaded and formed into a historical lookup table construct and compared to selected measured seal lifetime and performance measures, with the comparison relationships recorded. Then, during actual seal operation and utilization, electrical resistance can be measured of the in situ seal with carbon fibers, the value inserted into the historical look up table previously created for the seal or seal system, and a determination or calculation of seal performance or change or residual seal lifetime may be then accomplished, in a straight-forward, quick and accurate manner.

The material of the invention is not limited to carbon fibers, but to a host of fibers, fillers, and other molecules, or matter, that have a measurable change that correlates to a change or decay of a particular seal performance of interest. The material may include carbon nanotubes or other carbon shapes, that have various properties that change in correspondence with changing seal performance metrics. Such changes of the material properties need not be linear as compared to the seal performance criteria as long as the material changes and corresponding seal performance criteria are substantially deterministic.

Measurement of such materials may include changes in the material properties such as electrical or optical resistance or conductance, change of charge for piezoelectric types of materials, change or rotation of polarization (such that may occur with stress or strain), change of magnetic characteristics—such as may occur with material being a metal particle suspension. Changes in the measured qualities of vibration or response to signals may also be included. An example of such a case would be an ultrasonic interrogation of the seal or seal system from the outside measuring a change in response of the seal or seal system, and that change correlated to the possibly changing seal performance measure. Other interrogations of the seal with other sensing systems are possible.

Various other methods and systems may be utilized for the detection and quantization of changes of the seal member or seal system, bleedout (that is, resin or other constituents that migrate to the surface of the seal member) or exfoliated matter, worn matter or debris, matter attached or adhering to the seal or seal system, or even of leakage or controlled wear or disassociation of the embedded material into the seal system environment, that all may be correlated via known statistical methods to seal performance measurements. The “analytes” of interest in these systems may be connected with the flow of these substances or particulates past, onto, into, or out of, the seal or seal system.

Methods and systems which are capable of measuring trace amounts of matter, microorganisms, pharmaceuticals, hormones, viruses, antibodies, nucleic acids and other proteins are of great value to researchers, and may be indicators of seal performance change as well, whether shown to be permeating into, flowing past, or being released outbound from the seal member or sealing system.

Binding reactions, e.g., antigen-antibody reactions, nucleic acid hybridization techniques, and protein-ligand systems are further different types of measurement basis for determining seal performance in some applications. The high degree of specificity in many biochemical and biological binding systems has led to many assay methods and systems of value in research and diagnostics and these can now be utilized in seal systems as well. Typically, the existence of an analyte of interest is indicated by the presence or absence of an observable “label” attached to one or more of the binding materials. The invention, in one form, includes a label or binder device or composition, acting as the material in the previous discussion. In another form of the invention, a label or binder device or composition is applied to the seal or seal system in situ.

Of particular interest are labels which can be made to luminesce through photochemical, chemical, and electrochemical means. “Photoluminescence” is the process whereby a material is induced to luminesce when it absorbs electromagnetic radiation. Fluorescence and phosphorescence are types of photoluminescence.

“Chemiluminescent” processes entail the creation of luminescent species by chemical transfer of energy. “Electrochemiluminescence” entails creation of luminescent species electrochemically. Chemiluminescent assay techniques where a sample and in our case a surface of seal member or seal system, containing an analyte of interest is mixed with a reactant labeled with a chemiluminescent label may be utilized. The reactive mixture is incubated and some portion of the labeled reactant binds to the analyte. After incubation, the bound and unbound fractions of the mixture are separated and the concentration of the label in either or both fractions can be determined by chemiluminescent techniques. The level of chemiluminescence determined in one or both fractions indicates the amount of analyte of interest bound or associated with seal, indicating expected or immediately past or current seal performance.

Electrochemiluminescent (ECL) assay techniques are an improvement on chemiluminescent techniques. They provide a sensitive and precise measurement of the presence and concentration of an analyte of interest. In such techniques, the seal member or seal system or seal environment is exposed to a voltammetric working electrode in order to trigger luminescence. In the proper chemical environment, such electochemiluminescence is triggered by a voltage impressed on the working electrode at a particular time and in a particular manner. The light produced by the label is measured and indicates the presence or quantity of the analyte. For a fuller description of such ECL techniques, reference is made to PCT published application US85/01253 (WO86/02734), PCT published application number US87/00987, and PCT published application U.S. 88/03947.

It is desirable to carry out electrochemiluminecent assays without the need for a separation step during the assay procedure and to maximize the signal modulation at different concentrations of analyte so that precise and sensitive measurements can be made. Among prior art methods for nonseparation assays are those which employ microparticulate matter suspended in the assay sample to bind one or more of the binding components of the assay.

U.S. application Ser. No. 539,389 (PCT published application U.S. 89/04919) teaches sensitive, specific binding assay methods based on a luminescent phenomenon wherein inert microparticulate matter is specifically bound to one of the binding reactants of the assay system. The assays may be performed in a heterogeneous (one or more separation steps) assay format and may be used most advantageously in a homogeneous (nonseparation) assay format.

Applications for use with all the previously described inventions include tri-clamp gaskets such as for hygienic pipe couplings, although the invention can be utilized in a host of other applications. In these tri-clamp types of gaskets and seals, there is already a port through the seal clamp for a dosing of binding assay fluid, and for the sensor communication device. These tri-clamp seals in the past, utilized sensors placed into the passageway of the seal to measure characteristics of the flow past the seal, not the condition of the seal itself. The invention now may utilize a tool, test fluid or test matter, or sensor inserted into such a port in the seal or seal system to measure or interrogate or assay the material of the seal or seal system to make the necessary calculation of seal performance, while the seal is located in its operational environment.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A bearing system for bearing between two members, said bearing system comprising:
a polymer bearing disposed between the two members;
a measurement device disposed within said polymer bearing for measuring an aspect of at least one of said bearing and an environment between the two members, said measurement device creating a signal related to a measured said aspect; and
a communication device for communicating said signal away from said polymer bearing.

2. The bearing system of claim 1, wherein said measurement device includes at least one sensor that measures an indicator of bearing performance relative to said polymer bearing.

3. The bearing system of claim 2, wherein said bearing performance sensor includes at least one of a pressure sensor, a temperature sensor, a leakage sensor, a friction sensor, a strain sensor, a fluid film thickness sensor, a wear sensor, a deformation sensor, a vibration sensor, and a noise sensor.

4. The bearing system of claim 2, wherein said sensor measures at least one of a permanent condition and a temporary condition of said polymer bearing.

5. The bearing system of claim 1, wherein said measurement device includes a material disposed within said polymer bearing, said material changing its material properties dependent upon at least one of applied pressure, temperature, shear, strain, fretting, material loss, wear, exposure to system components, system fluid, and time.

6. The bearing system of claim 5, wherein said material includes one of a polymer material and a metal material.

7. The bearing system of claim 5, wherein said material includes a highly conductive polymer.

8. The bearing system of claim 1, wherein said measurement device is remotely powered.

9. The bearing system of claim 1, wherein said measurement device is self-powered.

10. The bearing system of claim 1, wherein said signal created is one of electrical, magnetic, and another wave.

11. The bearing system of claim 1, wherein said communication device is one of a wired and a wireless connection for transmitting said signal away from said polymer bearing.

12. The bearing system of claim 1, wherein said communication device is a radio-frequency identification device.

13. The bearing system of claim 12, wherein said radio-frequency identification device applies power to said measurement device.

14. The bearing system of claim 1, further comprising a signal processor, said communication device forwarding said signal to said signal processor for processing.

15. A bearing signal processor assembly, comprising:
a processor having a bearing signal input and a signal output, the bearing signal processor assembly being for a bearing system including a polymer bearing;
a memory connected to said processor, said memory including at least one of performance data and a plurality of thresholds regarding a plurality of polymer bearing systems, said processor configured for comparing at least one input signal to at least one of said performance data and said plurality of thresholds to create an output signal; and
a communication device configured for communicating said output signal to an operator.

16. The bearing signal processor assembly of claim 15, wherein said output signal is in the form of a feedback signal.

17. The bearing signal processor assembly of claim 16, wherein said feedback signal to said operator includes at least one of a stop signal, a reduce use signal, a reduce speed signal, a nominal signal, a bearing lifetime remaining signal, a bearing leakage signal, a bearing friction signal, a bearing system out of bounds signal, a maintenance required signal, and a bearing replacement signal.

18. The bearing signal processor assembly of claim 15, wherein said performance data are historical and are disposed in an Extensible Markup Language file.

19. The bearing signal processor assembly of claim 15, wherein said plurality of thresholds are disposed in an Extensible Markup Language file.

20. A computer-readable storage medium system, comprising:
a computer-readable storage medium having polymer bearing performance criteria stored thereon; and
a computing device, said computer-readable storage medium being mounted to said computing device, said computing device including:
a processor in operative communication with said computer-readable storage medium; and
a radio-frequency identification reader for obtaining a bearing signal, said radio-frequency identification reader passing an obtained said bearing signal to said processor;
wherein said computer-readable storage medium includes file information specifying a plurality of threshold bearing signals, said processor comparing said obtained bearing signal to said plurality of threshold bearing signals whereby said processor computes an output signal based upon whether said obtained bearing signal is within bounds of said plurality of threshold bearing signals.

21. A computer-readable storage medium system, comprising:
a computer-readable storage medium having polymer bearing performance criteria stored thereon; and
a computing device, said computer-readable storage medium being mounted to said computing device, said computing device including:
a processor in operative communication with said computer-readable storage medium; and
a communication device for obtaining a bearing signal from a polymer bearing, said communication device passing an obtained said bearing signal to said processor;
wherein said computer-readable storage medium includes file information specifying a plurality of threshold bearing signals, said processor comparing said obtained bearing signal to said plurality of threshold bearing signals whereby said processor computes an output signal based upon whether said obtained bearing signal is within bounds of said plurality of threshold bearing signals.

22. The computer-readable storage medium system of claim 21, wherein said processor forms at least one output signal in form of a stop signal, a reduce use signal, a reduce speed signal, a nominal signal, a bearing lifetime remaining signal, a bearing leakage signal, a bearing friction signal, a bearing system out of bounds signal, a maintenance required signal, and bearing replacement signal.

23. The computer-readable storage medium system of claim 21, further comprising a warning indicator, said processor activating said warning indicator.

24. The computer-readable storage medium system of claim 21, wherein said plurality of threshold bearing signals are disposed in an Extensible Markup Language file.

25. The computer-readable storage medium system of claim 21, wherein the computer-readable storage medium system is configured for communicating data to the internet, said data including at least one of said polymer bearing performance criteria, said obtained bearing signal, said plurality of threshold bearing signals, and said output signal.
